(19) United States
(12) Patent Application Publication
(10) Pub. No.: US 2013/0082491 A1
(43) Pub. Date: Apr. 4, 2013

(54) Vehicle Seat Accessory

(71) Applicant: Amido Rapkin, San Rafael, CA (US)

(72) Inventor: Amido Rapkin, San Rafael, CA (US)

(21) Appl. No.: 13/633,841

(22) Filed: Oct. 2, 2012

Related U.S. Application Data
(60) Provisional application No. 61/542,273, filed on Oct. 2, 2011.

(51) Int. Cl. B60N 2/44; B23P 11/00

(52) U.S. Cl. 297/188.06; 29/428

(57) ABSTRACT

Vehicle seat accessories configured to secure cargo are presented including: a rectangular planar panel having a stretch property, the rectangular planar panel sized to removably wrap around a vehicle seat back, where the rectangular panel includes an upper lengthwise edge, a lower lengthwise edge, a proximal crosswise edge, and a distal crosswise edge; an upper rolled hem disposed along the upper longitudinal edge, the upper rolled hem having a stretch property; a lower rolled hem disposed along the lower longitudinal edge, the lower rolled hem having a stretch property; a first fastener element disposed along the proximal crosswise edge; and a second fastener element disposed along the distal crosswise edge, where the second fastener element is adjustably and removably mated with the first fastener element when the vehicle seat accessory is wrapped around the vehicle seat back.

### PRIORITY CLAIM TO PROVISIONAL APPLICATION

A claim for priority is hereby made under the provisions of 35 U.S.C. §119 for the present application based upon U.S. Provisional Application No. 61/542,273, filed on Oct. 2, 2011, which is incorporated herein by reference.

### FIELD OF INVENTION

Embodiments provided herein generally relates to a vehicle accessory for use in organizing cargo that may be readily accessed by a vehicle occupant.

### BACKGROUND

Many spend countless hours commuting to and from work. Sales people and real estate appraisers, for example, are on the road many hours each day and like to keep their briefcase, files, maps, and phone etc. in a secure, orderly, clean, and accessible place. Often, a driver attempts to place objects in the passenger seat only to have the objects fall to the floor of the vehicle when the driver is forced to make a fast stop. In attempting to retrieve objects, drivers may place themselves and other in dangerous situations.

In addition, modern vehicles may be equipped with airbag deployment systems that provide greater safety for drivers. Ideally, any accessory in such an equipped vehicle will not interfere with safety systems. As such vehicle seat accessories are presented herein.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

As such vehicle seat accessories configured to secure cargo are presented including: a rectangular planar panel having a stretch property, the rectangular planar panel sized to removably wrap around a vehicle seat back, where the rectangular panel includes an upper lengthwise edge, a lower lengthwise edge, a proximal crosswise edge, and a distal crosswise edge; an upper rolled hem disposed along the upper longitudinal edge, the upper rolled hem having a stretch property; a lower rolled hem disposed along the lower longitudinal edge, the lower rolled hem having a stretch property; a first fastener element disposed along the proximal crosswise edge; and a second fastener element disposed along the distal crosswise edge, where the second fastener element is adjustably and removably mated with the first fastener element when the vehicle seat accessory is wrapped around the vehicle seat back, and where the fastener elements are releasably responsive to explosive decompression generated by a vehicle seat side airbag. In some embodiments, vehicle seat accessories further include: a number of loops disposed along the rectangular planar surface, the number of loops configured to receive and secure user items, where the number of loops have a property such as: an elastic property, a semi-elastic property, and a non-elastic property. In some embodiments, vehicle seat accessories further include: an upper cord slidingly disposed within the upper rolled hem, where a proximal end of the upper cord is secured with the proximal crosswise edge and a distal end of the upper cord is secured with the distal crosswise edge, and where the upper rolled hem is configured to provide an access point along the upper cord; and an upper cord locking device configured to adjust the upper cord. In some embodiments, vehicle seat accessories further include: a lower cord slidingly disposed within the lower rolled hem, where a proximal end of the lower cord is secured with the proximal crosswise edge and a distal end of the lower cord is secured with the distal crosswise edge, and where the lower rolled hem is configured to provide an access point along the lower cord; and a lower cord locking device configured to adjust the lower cord.

In other embodiments, methods for utilizing a vehicle seat accessory are presented including: providing a vehicle seat back; providing a vehicle seat accessory, the vehicle seat accessory including, a rectangular planar panel having, a stretch property, the rectangular planar panel sized to removably wrap around a vehicle seat back, where the rectangular panel includes an upper lengthwise edge, a lower lengthwise edge, a proximal crosswise edge, and a distal crosswise edge; an upper rolled hem disposed along the upper longitudinal edge, the upper rolled hem having a stretch property; a lower rolled hem disposed along the lower longitudinal edge, the lower rolled hem having a stretch property; a first fastener element disposed along the proximal crosswise edge; and a second fastener element disposed along the distal crosswise edge, where the second fastener element is adjustably and removably mated with the first fastener element when the vehicle seat accessory is wrapped around the vehicle seat back, and where the fastener elements are releasably responsive to explosive decompression generated by a vehicle seat side airbag; wrapping the vehicle seat accessory around the vehicle seat back; mating the fastener elements; locating the fastener elements along an outside edge of the vehicle seat corresponding with the vehicle seat side airbag; and stowing cargo in a pocket formed by the vehicle seat accessory.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative representation of a vehicle seat accessory in accordance with embodiments of the present invention;

FIG. 2 is an illustrative representation of a vehicle seat accessory in accordance with embodiments of the present invention;

FIG. 3 is an illustrative representation of a vehicle seat accessory in accordance with embodiments of the present invention;

FIG. 4 is an illustrative representation of a vehicle seat accessory in accordance with embodiments of the present invention; and

FIG. 5 is an illustrative flowchart of methods for utilizing a vehicle seat accessory in accordance with embodiments provided herein.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

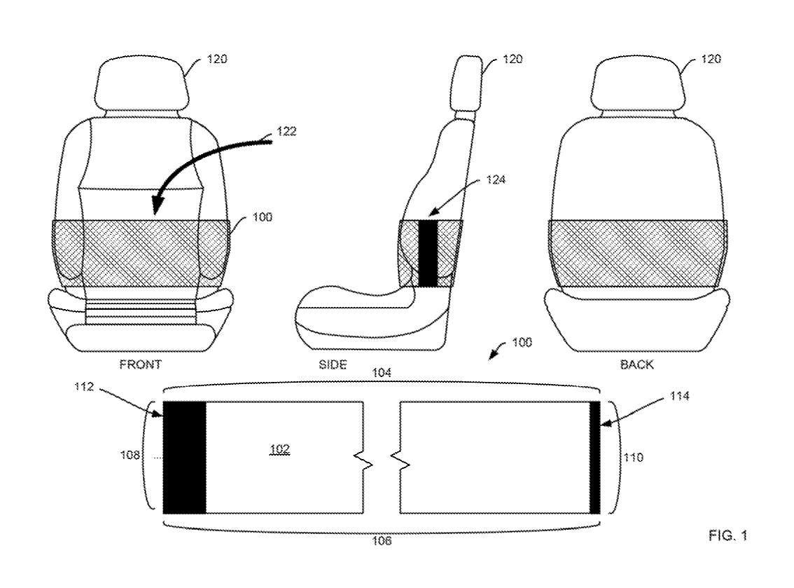

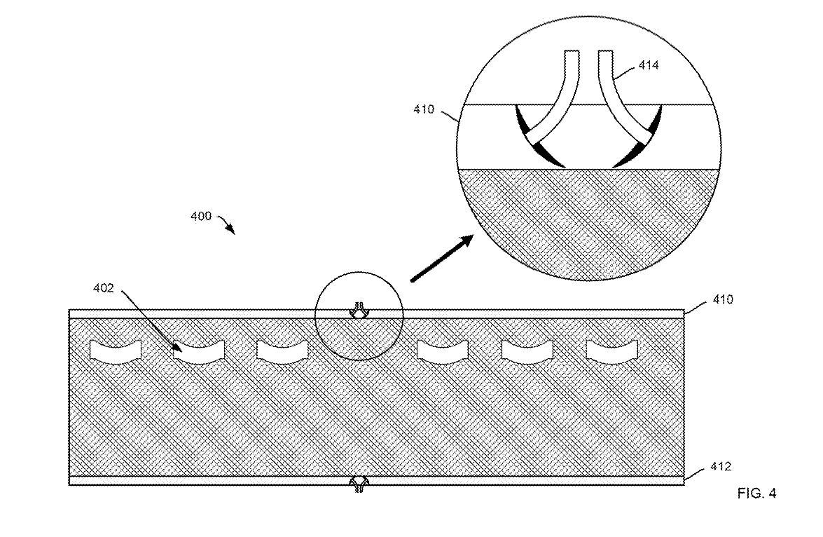

FIG. 1 is an illustrative representation of a vehicle seat accessory 100 in accordance with embodiments of the present invention. In particular, rectangular planar panel 102 is illustrated. Rectangular planar panel 102 may be sized to removably wrap around a vehicle seat back as illustrated. In order to more easily accommodate a variety of vehicle seat sizes and a shapes of cargo, rectangular planar panel embodiments may be manufactured from a stretchable material such as, for example, a mesh fabric, a netting fabric, a stretch fabric, a terrycloth fabric, a double knit fabric, a spandex fabric, a LYCRA® fabric, a nylon fabric, and a polyester fabric or any other man-made stretchable fabric without limitation. Rectangular planar panel 102 may include upper lengthwise edge 104, lower lengthwise edge 106, proximal crosswise edge 108, and distal crosswise edge 106. In some embodiments, upper longitudinal edge 104 may include an upper rolled hem (not shown) disposed along the upper longitudinal edge and having a stretch property. In addition, in some embodiments, lower longitudinal edge 106 may include a lower rolled hem (not shown) disposed along, the lower longitudinal edge and having a stretch property. Rolled hem embodiments will be discussed in further detail below for FIG. 4.

Further as illustrated, first fastener element 112 may be disposed along proximal crosswise edge 108. Additionally, a second fastener element 114 may be disposed along distal crosswise edge 110. Fastener element embodiments may be manufactured from a stretch or non-stretch material without limitation. In embodiments, fastener elements may include a hook and loop fastener element. In other embodiments, fastener elements may include a clip fastener element, a snap element, and a button element without limitation. By utilizing a hook and loop fastener element, the elements may be adjustably and removably mated with each other when the vehicle seat accessory is wrapped around the vehicle seat back. It may be appreciated that utilizing a hook and loop fastener element may provide an adjustment feature such that excess fabric or overlap may be secured between the vehicle seat accessory and the vehicle seat back. Furthermore, embodiments provided may be releasably responsive to explosive decompression generated by a vehicle seat side airbag. As such, embodiments are configured to not interfere with safety features of modem vehicles. In embodiments, fastener elements may be aligned with air bag deployment openings 124.

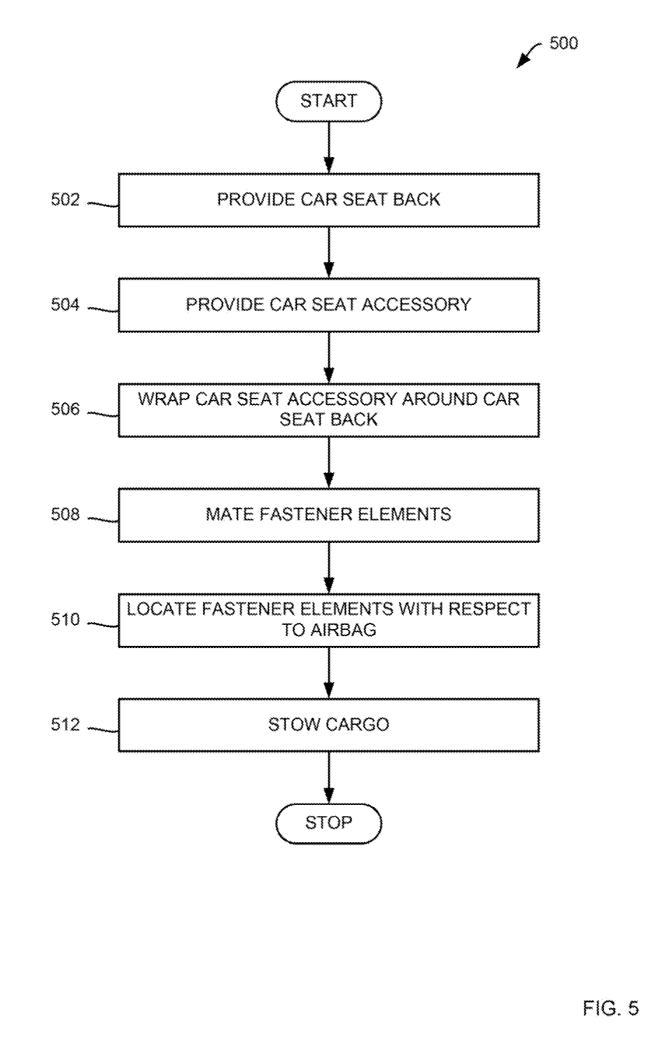

In operation, when vehicle seat accessory 100 is wrapped around vehicle seat 120, a stowage area may be utilized by placing objects as illustrated by arrow 122, In this manner, objects may be secured and recovered easily and safely while utilizing the vehicle. It may be further appreciated that since embodiments presented herein are manufactured from a stretchable fabric, the vehicle seat accessory may remain wrapped around a vehicle seat while in use by a seated passenger. Methods for utilizing vehicle seat accessories will be discussed in further detail below for FIG. 5.

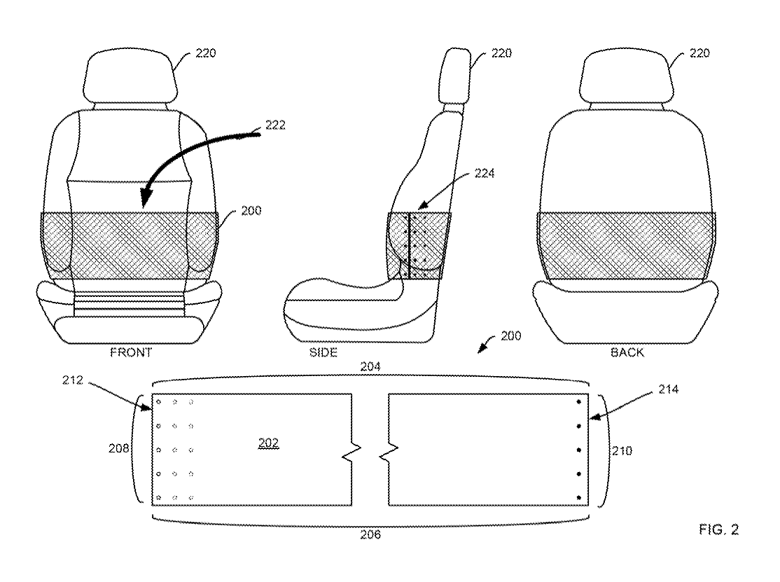

FIG. 2 is an illustrative representation of a vehicle seat accessory 200 in accordance with embodiments of the present invention. In particular, rectangular planar panel 202 is illustrated. Rectangular planar panel 202 may be sized to removably wrap around a vehicle seat back as illustrated. In order to more easily accommodate a variety of vehicle seat sizes and a shapes of cargo, rectangular planar panel embodiments may be manufactured from a stretchable material such as, for example, a mesh fabric, a netting fabric, a stretch fabric, a terrycloth fabric, a double knit fabric, a spandex fabric, a LYCRA® fabric, a nylon fabric, and a polyester fabric or any other man-made stretchable fabric without limitation. Rectangular planar panel 202 may include upper lengthwise edge 204, lower lengthwise edge 206, proximal crosswise edge 208, and distal crosswise edge 206. In some embodiments, upper longitudinal edge 204 may include an upper rolled hem (not shown) disposed along the upper longitudinal edge and having a stretch property. In addition, in some embodiments, lower longitudinal edge 206 may include a lower rolled hem (not shown) disposed along the lower longitudinal edge and having a stretch property. Rolled hem embodiments will be discussed in further detail below for FIG. 4.

Further as illustrated, first fastener element 212 may be disposed along proximal crosswise edge 208. Additionally, a second fastener element 214 may be disposed along distal crosswise edge 210. In embodiments, fastener elements may include snap elements, in other embodiments, fastener elements may include a clip fastener element, a hook and loop fastener element, and a button element without limitation. By utilizing snap elements, the elements may be adjustably and removably mated with each other when the vehicle seat accessory is wrapped around the vehicle seat back. It may be appreciated that utilizing a snap element may provide an adjustment feature such that excess fabric or overlap may be secured between the vehicle seat accessory and the vehicle seat back. Furthermore, embodiments provided may be releasably responsive to explosive decompression generated by a vehicle seat side airbag. As such, embodiments are configured to not interfere with safety features of modem vehicles. In embodiments, fastener elements may be aligned with air bag deployment openings 224.

In operation, when vehicle seat accessory 200 is wrapped around vehicle seat 220, a stowage area may be utilized by placing objects between vehicle seat accessory embodiments and a vehicle seats as illustrated by arrow 222. In this manner, objects may be secured and recovered easily and safely while utilizing the vehicle. It may be further appreciated that since embodiments presented herein are manufactured from a stretchable fabric, the vehicle seat accessory may remain wrapped around a vehicle seat while in use by a seated passenger. In some embodiments, the vehicle seat accessory may be lowered around a seat when not in use. Methods for utilizing vehicle seat accessories will be discussed in further detail below for FIG. 5.

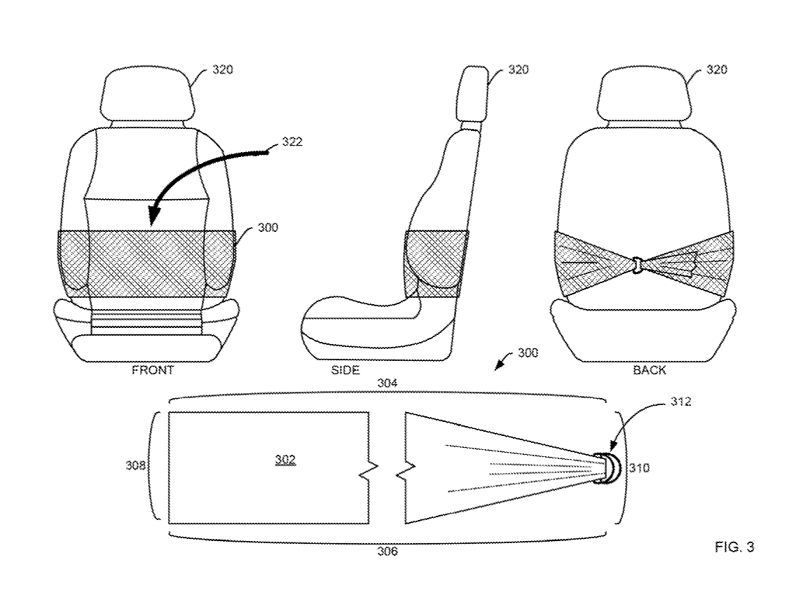

FIG. 3 is an illustrative representation of a vehicle seat accessory in accordance with embodiments of the present invention. In particular, rectangular planar panel 302 is illustrated. Rectangular planar panel 302 may be sized to removably wrap around a vehicle seat back as illustrated. In order to more easily accommodate a variety of vehicle seat sizes and a shapes of cargo, rectangular planar panel embodiments may be manufactured from a stretchable material such as, for example, a mesh fabric, a netting fabric, a stretch fabric, a terrycloth fabric, a double knit fabric, a spandex fabric, a LYCRA® fabric, a nylon fabric, and a polyester fabric or any other man-made stretchable fabric, without limitation. Rectangular planar panel 302 may include upper lengthwise edge 304, lower lengthwise edge 306, proximal crosswise edge 308, and distal crosswise edge 306. In some embodiments, upper longitudinal edge 304 may include an upper rolled hem (not shown) disposed along the upper longitudinal edge and having a stretch property. In addition, in some embodiments, lower longitudinal edge 306 may include a lower rolled hem (not shown) disposed along the lower longitudinal edge and having a stretch property. Rolled hem embodiments will be discussed in further detail below for FIG. 4.

Further as illustrated, fastener element 312 may be disposed along distal crosswise edge 310. In embodiments, fastener elements may include a double ring element. In other embodiments, fastener elements may include a clip fastener element, a snap element, a hook and loop fastener element, and a button element without limitation. By utilizing double ring elements, proximal crosswise edge may be inserted into the rings to adjustably and removably secure crosswise edges with each other when the vehicle seat accessory is wrapped around the vehicle seat back. It may be appreciated that utilizing a double ring element may provide an adjustment feature such that excess fabric or overlap may be secured between the vehicle seat accessory and the vehicle seat back.

In operation, when vehicle seat accessory 300 is wrapped around vehicle seat 320, a stowage area may be utilized by placing objects between vehicle seat accessory embodiments and a vehicle seats as illustrated by arrow 322. In this manner, objects may be secured and recovered easily and safely while utilizing the vehicle. It may be further appreciated that since embodiments presented herein are manufactured from a stretchable fabric, the vehicle seat accessory may remain wrapped around a vehicle seat while in use by a seated passenger. Methods for utilizing vehicle seat accessories will be discussed in further detail below for FIG. 5.

FIG. 4 is an illustrative representation of a vehicle seat accessory 400 in accordance with embodiments of the present invention. In particular, any number of loops 402 may be disposed along the rectangular planar surface of vehicle seat accessory 400. Loops 402 may be disposed along inner or outer surface of vehicle seat accessory embodiments in any desirable position without departing from embodiments provided herein. As may be appreciated, loops 402 may be utilized to receive and secure user items. As such, it may be advantageous to manufacture loops having one or more properties such as, an elastic property, a semi-elastic property, and a non-elastic property. Still further, in other embodiments not shown, loops may be individually adjustable to accommodate different objects.

Further as illustrated, vehicle seat accessory 400 may include upper rolled hem 410 and lower rolled hem 412. Hems may be manufactured from a stretch property in some embodiments. In some embodiments, hems may be configured having upper cord 414 slidingly disposed within the upper rolled hem 410. In order to provide adjustment features, a proximal end of the upper cord may be secured with the proximal crosswise edge. Likewise, a distal end of the upper cord may be secured with the distal crosswise edge. In addition, as may be seen upper rolled hem may be configured to provide an access point for the upper cord. In some embodiments, cords may be tied or otherwise locked using any locking device known in the art. Cords may be selected from a variety of materials including: a polymeric non-elastic cord, a polymeric elastic cord, a natural fiber cord, a blended fiber cord, and a shock cord. In some embodiments, hems may include an elastic band (not shown) which would provide a stretchable feature for embodiments provided herein. In addition, it may be appreciated that any combination of rolled hems haying cords and rolled hems not having cords may be utilized without departing from embodiments provided herein. For example, in one embodiment, an elastic band may be mechanically coupled with the hem and bonded with the vehicle seat accessory.

FIG. 5 is an illustrative flowchart 500 of methods for utilizing a vehicle seat accessory in accordance with embodiments provided herein. At a first step 502, a vehicle seat back is provided. At a next step 504, a vehicle seat accessory in accordance with embodiments provided herein is provided. At a next step 506, the vehicle seat accessory may be wrapped around the vehicle seat back. At a next step 508, fastener elements may be mated. Fastener elements may be mated to one another in a manner that adjusts vehicle seat accessory embodiments to fit a particular vehicle seat back. It may be appreciated that many types of vehicle seats may be utilized without departing from embodiments provided herein such as automobiles, trucks, planes, trains, or any other vehicle known in the art. At a next step 510, fastener elements may be located with respect to an airbag deployment area. Embodiments provided may be particularly useful in automobiles having airbag restraint systems. At a next step 512, the method stows cargo in the vehicle seat accessory whereupon the methods ends. In some embodiments, methods may further include selectively adjust an upper cord or a lower cord utilizing embodiments provided herein. In still other embodiments, methods may further include securing a user item in any of a number of loops as provided herein. It may be further appreciated that when an airbag deploys, as discussed above, vehicle seat accessories may be configured to unfasten to accommodate expansion of the airbag in a step not illustrated.

While this invention has been described in terms of several embodiments, there are alterations, permutations, and equivalents, which fall within the scope of this invention. It should also be noted that there are many alternative ways of implementing the methods and apparatuses of the present invention. Furthermore, unless explicitly stated, any method embodiments described herein are not constrained to a particular order or sequence. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. A vehicle seat accessory configured to secure cargo comprising:
a rectangular planar panel having a stretch property, the rectangular planar panel sized to removably wrap around a vehicle seat back, wherein the rectangular panel includes an upper lengthwise edge, a lower lengthwise edge, a proximal crosswise edge, and a distal crosswise edge;
an upper rolled hem disposed along the upper longitudinal edge, the upper rolled hem having a stretch property;
a lower rolled hem disposed along the lower longitudinal edge, the lower rolled hem having a stretch property;
a first fastener element disposed along the proximal crosswise edge; and
a second fastener element disposed along the distal crosswise edge, wherein the second fastener element is adjustably and removably mated with the first fastener element when the vehicle seat accessory is wrapped around the vehicle seat back, and wherein the fastener elements are releasably responsive to explosive decompression generated by a vehicle seat side airbag.

2. The vehicle seat accessory of claim 1, further comprising:
a plurality of loops disposed along the rectangular planar surface, the plurality of loops configured to receive and secure user items, wherein the plurality of loops have a property selected from the group consisting of: an elastic property, a semi-elastic property, and a non-elastic property.

3. The vehicle seat accessory of claim 1, further comprising:
an upper cord slidingly disposed within the upper roiled hem, wherein a proximal end of the upper cord is secured with the proximal crosswise edge and a distal end of the upper cord is secured with the distal crosswise edge, and wherein the upper rolled hem is configured to provide an access point along the upper cord; and
an upper cord locking device configured to adjust the upper cord.

4. The vehicle seat accessory of claim 3, wherein the upper cord is a cord selected from the group consisting of a polymeric non-elastic cord, a polymeric elastic cord, a natural fiber cord, a blended fiber cord, an elastic band, and a shock cord.

5. The vehicle seat accessory of claim 1, further comprising:
a lower cord slidingly disposed within the lower rolled hem, wherein a proximal end of the lower cord is secured with the proximal crosswise edge and a distal end of the lower cord is secured with the distal crosswise edge, and wherein the lower rolled hem is configured to provide an access point along the lower cord; and
a lower cord locking device configured to adjust the lower cord.

6. The vehicle seat accessory of claim 5, wherein the upper cord is a cord selected from the group consisting of a polymeric non-elastic cord, a polymeric elastic cord, a natural fiber cord, a blended fiber cord, an elastic band, and a shock cord.

7. The vehicle seat accessory of claim 1, wherein the fastener elements are configured to secure any excess portion of the proximal crosswise edge between the vehicle seat accessory and the vehicle seat back.

8. The vehicle seat accessory of claim 1, wherein the fastener elements are selected from the group consisting of a hook and loop fastener element, a clip fastener element, a snap element, a double ring element, and a button element.

9. The vehicle seat accessory of claim 1, wherein the rectangular planar panel is selected from the group consisting of: a mesh fabric, a netting fabric, a stretch fabric, a terrycloth fabric, a double knit fabric, a spandex fabric, a LYCRA® fabric, a nylon fabric, and a polyester fabric.

10. A method of utilizing a vehicle seat accessory comprising:
providing a vehicle seat back;
providing a vehicle seat accessory, the vehicle seat accessory including,
a rectangular planar panel having a stretch property, the rectangular planar panel sized to removably wrap around a vehicle seat back, wherein the rectangular panel includes an upper lengthwise edge, a lower lengthwise edge, a proximal crosswise edge, and a distal crosswise edge;
an upper rolled hem disposed along the upper longitudinal edge, the upper rolled hem having a stretch property;
a lower rolled hem disposed along the lower longitudinal edge, the lower rolled hem haying a stretch property;
a first fastener element disposed along the proximal crosswise edge; and
a second fastener element disposed along the distal crosswise edge, wherein the second fastener element is adjustably and removably mated with the first fastener element when the vehicle seat accessory is wrapped around the vehicle seat back, and wherein the fastener elements are releasably responsive to explosive decompression generated by a vehicle seat side airbag;
wrapping the vehicle seat accessory around the vehicle seat back;
mating the fastener elements; and
locating the fastener elements along an outside edge of the vehicle seat corresponding with the vehicle seat side airbag.

11. The method of claim 10, further comprising:
selectively adjusting the upper lengthwise edge of the vehicle seat accessory utilizing an upper cord, the upper cord slidingly disposed within the upper rolled hem, wherein a proximal end of the upper cord is secured with the proximal crosswise edge and a distal end of the upper cord is secured with the distal crosswise edge, and wherein the upper rolled hem is configured to provide access to a point the upper cord; and
an upper cord locking device configured to adjust the upper cord.

12. The method of claim 10, further comprising:
selectively adjusting the lower lengthwise edge of the vehicle seat accessory utilizing a lower cord, the lower cord slidingly disposed within the lower rolled hem, wherein a distal end of the lower cord is secured with the distal crosswise edge and a distal end of the lower cord is secured with the distal crosswise edge, and wherein the lower rolled hem is configured to provide access to a point the lower cord; and
a lower cord locking device configured to adjust the lower cord.

13. The method of claim 10, further comprising:
securing a user item in one of a plurality of loops, the plurality of loops disposed along the rectangular planar surface, wherein the plurality of loops are configured to receive and secure the user item, wherein the plurality of loops have a property selected from the group consisting of an elastic property, a semi-elastic property, and a non-elastic property.

14. The method of claim 10, wherein the fastener elements are selected from the group consisting of: a hook and loop fastener element, a clip fastener element, a snap element, a double ring element, and a button element.

15. The method of claim 10, further comprising:
stowing cargo in a pocket formed by the vehicle seat accessory.
